(19) United States
(12) Patent Application Publication
(10) Pub. No.: US 2006/0229890 A1
(43) Pub. Date: Oct. 12, 2006

(54) Method and system for employee compensation planning

(75) Inventors: Juergen Sattler, Wiesloch (DE); Joachim Gaffga, Wiesloch (DE)

Correspondence Address: KENYON & KENYON LLP, 1500 K STREET N.W., SUITE 700, WASHINGTON, DC, 20005, US

(73) Assignee: SAP Aktiengesellschaft

(21) Appl. No.: 11/099,613

(22) Filed: Apr. 6, 2005

(51) Int. Cl. G06Q 99/00

(52) U.S. Cl. 705/1

(57) ABSTRACT

Methods and apparatus for compensation planning are provided. A request to initiate a compensation planning process for an organization may be received at a compensation planning application program executing on a computer system. The compensation planning application may generate a query to one or more databases to obtain performance indicator information that indicates the performance of units within the organization, and that information may be used to generate a data set that indicates the available compensation to be allocated and that lists units in the organization. The data may be transmitted to a first manager to allocate the available compensation among the units. In some embodiments, the organization has a hierarchical structure, and the data or a derivate may be transmitted to each manager in the organization, stating with the highest level managers and proceeding downward through the hierarchical structure, to allocate the amount of compensation available to each manager among the units or employees of which that manager is directly responsible.

### BACKGROUND

Compensation for salaried employees, such as for annual bonuses, is typically allocated on an annual basis. Often, a compensation planning process cannot begin until an amount of money available for an entire class or group of employees is known. The amount of money available may be based, for example, on a previous year's profits or on an estimate of a coming year's profits. Once the amount of money is known, it usually falls to a human resources manager to allocate the money, or percentages of total available funds, among the class or group of employees. Managers of the group or class of employees may, for example, base the allocation on year-end performance appraisals. Due to the sensitive nature of the information used to allocate salary, a human resources manager in isolation from other personnel typically carries out the allocation process. Data under consideration as well as preliminary decisions on how the funds will be allocated are not dynamically distributed and are typically not shared with direct managers, lower level managers, or other informally responsible persons. Year-end performance appraisals, which may be considered by the human resources manager, typically paint an overly generic picture of an employee. Key performance indicators of individual employees undergoing compensation review, or performance indicators for teams or business units, are typically not considered or interpreted by the human resources manager. Thus, there is a need in the art for a new compensation planning tool to overcome these and other deficiencies.

### BRIEF DESCRIPTION OF DRAWINGS

FIG. 1 is a data flow diagram that depicts a process for employee compensation planning according to an embodiment of the present invention.

FIG. 2 is a block diagram that shows a hierarchical management structure for an organization for which employee compensation may be planed according to an embodiment of the present invention.

FIG. 3 is a block diagram that shows communications between managers in an organization and a compensation planning application according to an embodiment of the present invention.

FIG. 4 is a block diagram that shows features of a manager's computer device and a backend computer device to be used for compensation planning according to an embodiment of the present invention.

FIGS. 5-6 are block diagrams that show examples of manager's views of a compensation planning data according to an embodiment of the present invention.

FIG. 7 is a flowchart diagram of a method for employee compensation planning according to an embodiment of the present invention.

### DETAILED DESCRIPTION OF EMBODIMENTS

Embodiments of the present invention are directed to a method and system for determining the amount of compensation to be paid to employees. According to embodiments on the invention, a compensation planning process is distributed from the top down. In such embodiments, a software tool may be used by a top level manager to assign an amount of compensation to each of a group of business units. A stand alone form may be used to initiate the planning process, and the planning data may be distributed as an enhanced spreadsheet data set. The software tool may extract key performance indicator data from a database and include that information in the planning data that is distributed to the managers. A cascading distribution within the management community may be employed which distributes the compensation planning process from the top down, and then aggregates the results from the bottom management layer, such as by final submission of data to the compensation planning system. During the process, an appropriate sub-file may be sent to the manager of each of business unit, who may then divide compensation among sub-units, and an appropriate sub-file may then sent to the managers of these subunits. It may be understood that the examples discussed below are for illustration purposes only and are not intended to limit the configuration to that shown.

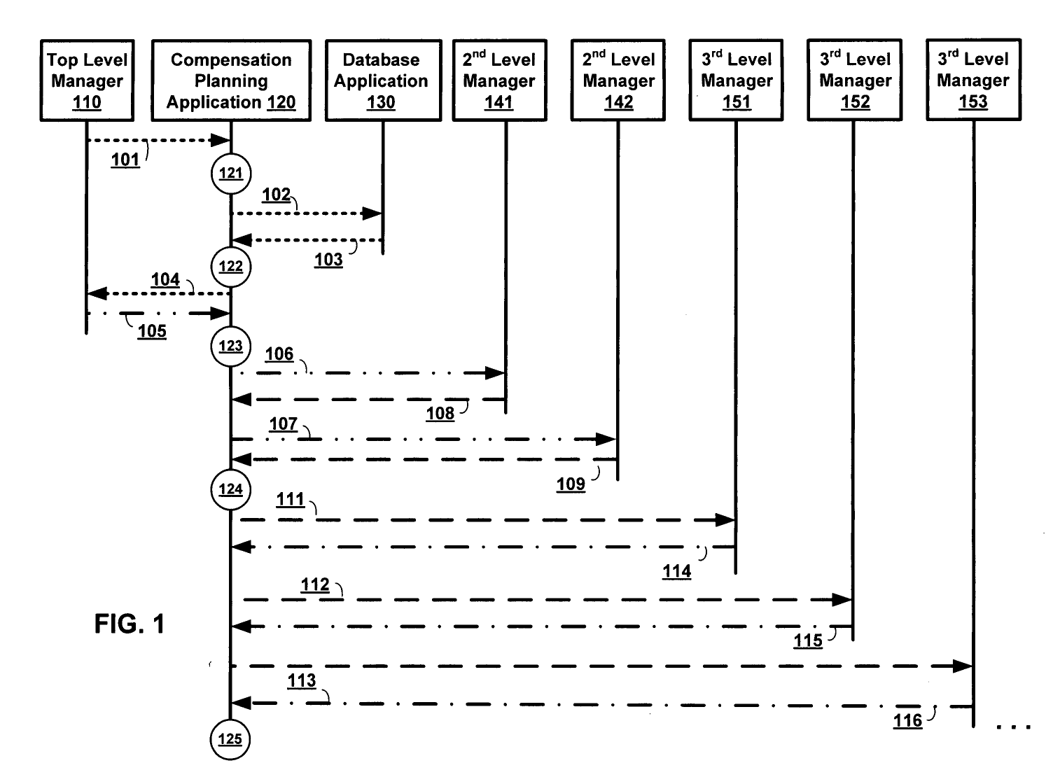

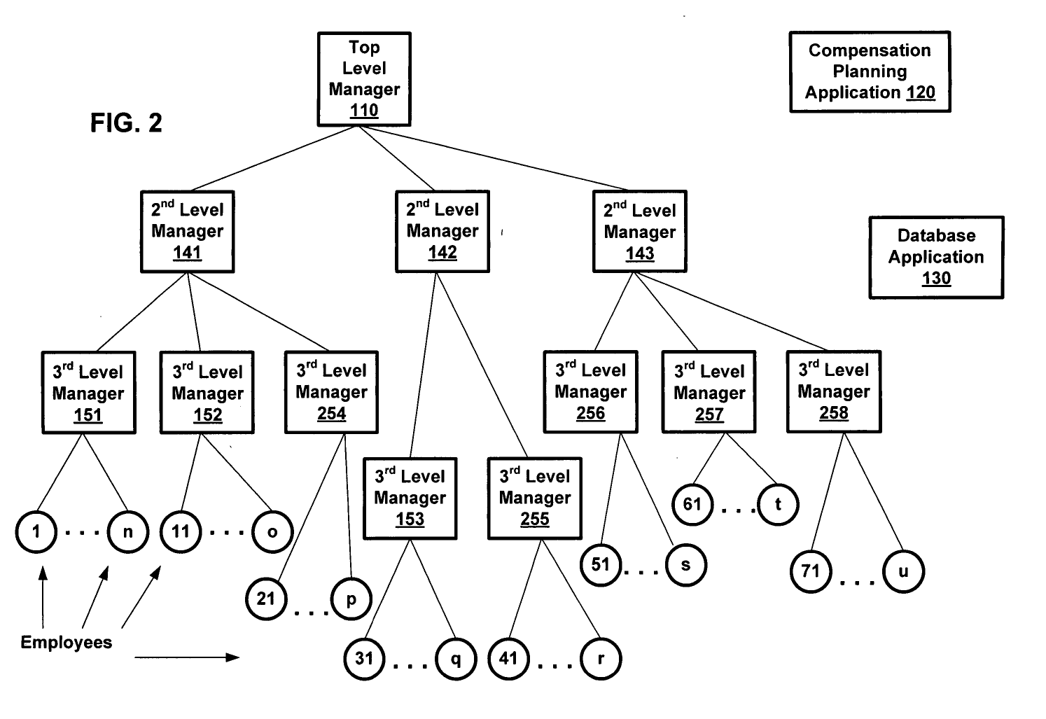

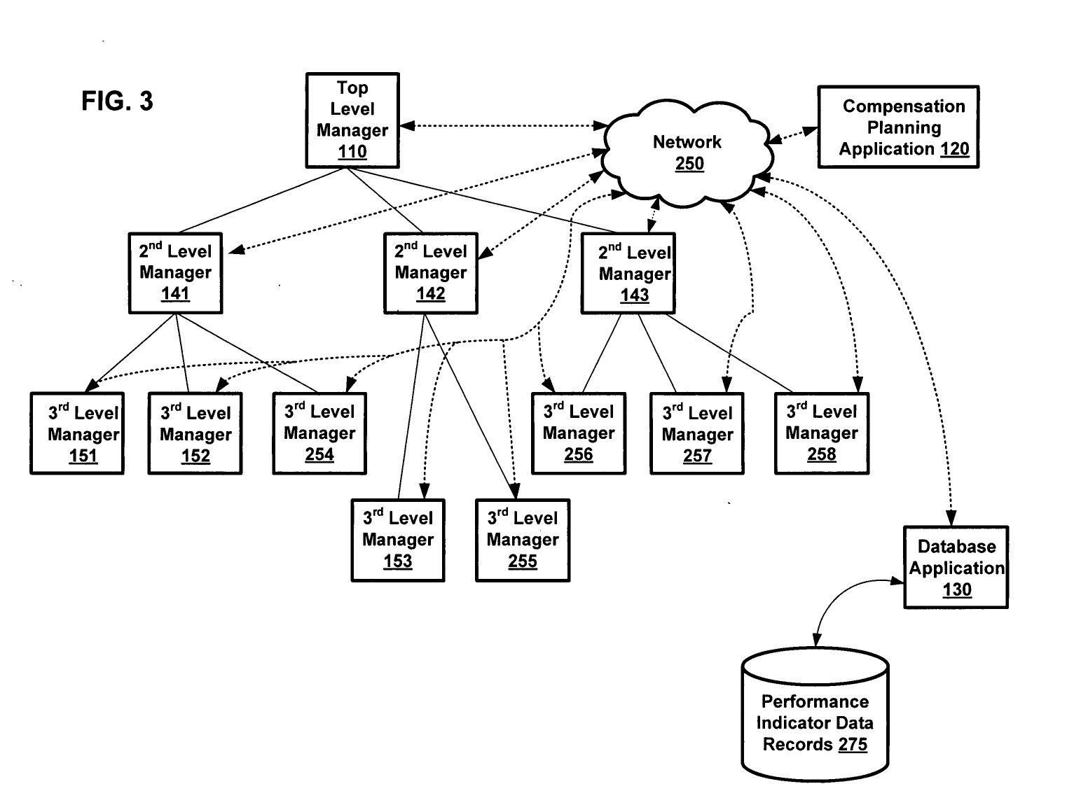

FIG. 1 is a data flow diagram that depicts a process for employee compensation planning according to an embodiment of the present invention. FIG. 1 shows a top level manager 110, two second level managers (141-142), and three third level managers (151-153), each of whom may be managers within an organization, such as a company. FIG. 1 also shows a compensation planning application 120 and a database application 130, each of which may be software applications executing on one or more computer devices. The managers in this organization may have management responsibilities as illustrated in FIG. 2, which shows a hierarchical management structure for an organization for which employee compensation may be planed according to an embodiment of the present invention. As shown in FIG. 2, top level manager 110 may be responsible for the entire organization, and three second level managers (141-143) may report to top level manager 110. In the example shown, a number of third level managers (151, 152, 254, etc.) report to each second level manager, and a number of employees (1 to n, 11 to o, etc.) report to each third level manager. Each of these managers would typically communicate and perform work functions by using a computer device, such as a personal computer, personal digital assistant, etc., through which the managers may interact with compensation planning application 120, as shown in FIG. 3 and discussed further below.

The compensation planning process shown in FIG. 1 may be started when top level manger 110 sends a request (shown as 101) to compensation planning application 120 requesting initiation of a compensation planning process for the organization. The request may be sent as an electronic form, such as a word processing document or a document in some other format, with defined fields for specifying information. Compensation planning application 120 may process this request (121) and generate a query (102) that is sent to a database application 130 to obtain performance indicator information relating to the compensation planning process. The performance indicator information may include information that indicates the aggregate performance of team or a group of employees, such as all sales employees or all employees in the United States sales department. An example of a performance indicator for a unit may be the amount of sales revenue generated by that unit. Database application 130 may perform this query and return the requested information (103). Compensation planning application 120 may then generate a compensation planning data set (122), which may include the performance indicator information that was received. The compensation planning data may group employees in the organization into units and sub-units, such as those shown in FIG. 2. As used herein, a unit in the organization may be any subset of the organization, of any size, and thus a unit is not necessarily the size of a entire division. A sub-unit would itself also be a unit of the organization. The compensation planning data may be in a format that is recognized by a commonly used application program, such as a file in a database application program format (e.g., a .XLS file for Microsoft Excel®), a file in a word processor application program format (e.g., a .WPD file for Corel WordPerfect®), or some other format (e.g., a .PDF file for Adobe Acrobat®).

As shown in FIG. 1, the compensation planning data may then be transmitted (104) from the compensation planning application 120 to top level manager 110 to allocate an amount of compensation among a plurality of units of the organization. For example, top level manager 110 may divide a $500,000 budget of available bonus money among the departments headed by second level manager 141 and second level manager 142 (i.e., the unit for which they are responsible). Top level manager 110 may then return the compensation planning data (105) with the allocation information to compensation planning application 120, which may generate (123) compensation planning data that are tailored to each second level manager. Such tailored compensation planning data may specify the subunits for which each second level manager is responsible. In embodiments, compensation planning application 120 may create a compensation planning data set for each second level manager by limiting access of the appropriate second level manager to the information in the compensation planning data that is relevant to that manager's unit. For example, certain rows in a spreadsheet may be hidden so that only certain user's may have access to that information, thus protecting information to block access by recipients of the spreadsheet data file to data for groups for which the recipient does not have responsibility. Of course, compensation planning application 120 may also create these compensation planning data files in other ways, such as by deleting the information that is not relevant.

Compensation planning application 120 may then transmit (106-107) the compensation planning data to the appropriate second level manager with their unit's allocation amount, and the second level managers may allocate an amount of compensation among a plurality of subunits of the unit. For example, second level manager 141, who may be responsible for the functional sales department and may have been allocated $250,000 in bones money for that unit, may allocate $100,000 of that money to the United States sales subunit, $100,000 of that money to the European sales subunit, and $50,000 of that money to the Asian sales subunit. Each second level sales manager may then transmit (108-109) the compensation planning data with the subunit allocations back to the compensation planning application.

Compensation planning application 120 may then create a compensation planning data file (124) for each third level manager by limiting access of the appropriate third level manager to the information in the compensation planning data that is relevant to that manager's sub-unit. These compensation planning data files with the subunit allocations may then be transmitted to the third level managers of the subunit's (111-113), who may allocate that subunit's money to employees within that subunit. For example, third level manager 151 may be responsible for sales in California, may have been allocated $10,000 to distribute, and may allocate $5,000 to each of two salespersons in that subunit. The compensation data with the subunit allocation may then be transmitted (114-116) back to the compensation planning system 120, which may compile a final compensation plan (125) based on data files received from the subunit managers. While there are three management levels in the example shown in FIG. 1, of course in other examples there may be more or less management levels (e.g., sub-sub-units), the various units and subunits may have different depths, and as shown in FIG. 2 the units and subunits may have different sizes.

As discussed above, FIG. 2 shows a hierarchical management structure for an organization for which employee compensation may be planed. FIG. 2 shows three units, one headed by second level manager 141, one headed by second level manager 142, and one headed by second level manager 143. The first unit has three subunits, one of which is headed by third level manager 151 and contains employees 1 to n, one of which is headed by third level manager 152 and contains employees 11 to o, and one of which is headed by third level manager 254 and contains employees 21 to p. The second unit has two subunits, one of which is headed by third level manager 153 and contains employees 31 to q, and one of which is headed by third level manager 255 and contains employees 41 to r. Finally, the third unit has three subunits, one of which is headed by third level manager 256 and contains employees 51 to s, one of which is headed by third level manager 257 and contains employees 61 to t, and one of which is headed by third level manager 258 and contains employees 71 to u. In addition to managers and employees, FIG. 2 also shows database application 130 and compensation planning application 120, which communicates with the managers as shown in FIG. 3.

FIG. 3 is a block diagram that shows communications between managers in an organization and a compensation planning application according to an embodiment of the present invention. FIG. 3 is similar to FIG. 2, but FIG. 3 also shows a network 250, which may be any type of communications network such as the Internet, an intranet, a local area network (LAN), a wide area network, etc. As shown in FIG. 3, each of the managers may communicate with compensation planning application 120 through network 250. In some embodiments, these communications are send as electronic mail (email) messages, which are familiar to persons of skill in the art. Compensation planning application 120 may also communicate through network 250 with database application 130, which may maintain a plurality of performance indicator data records, as is familiar to persons of skill in the art.

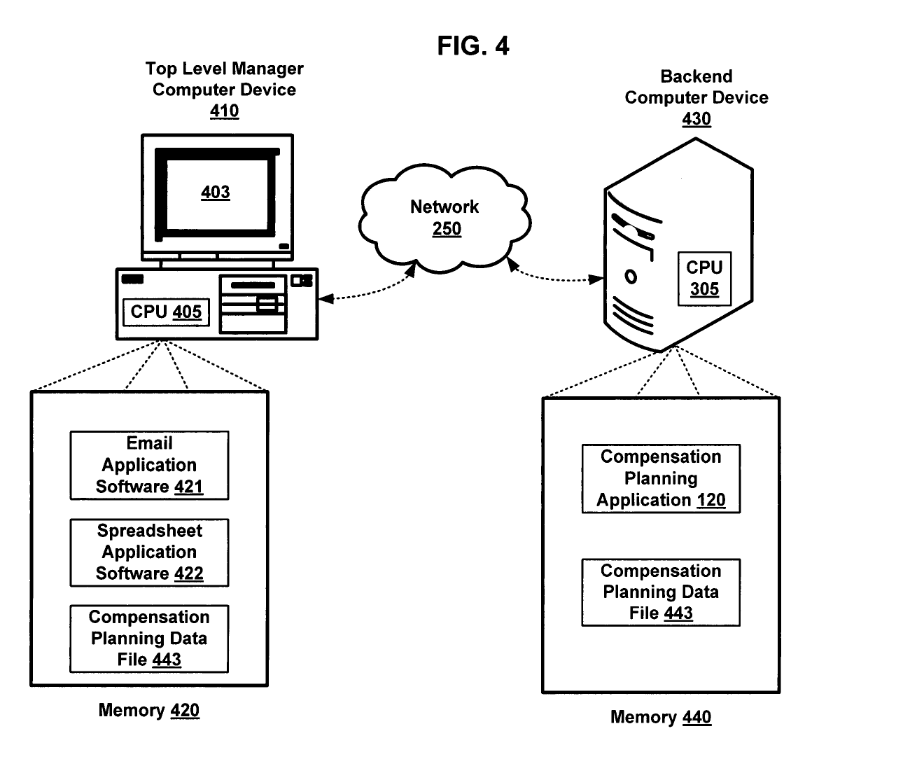

FIG. 4 is a block diagram that shows features of a manager's computer device and a backend computer device to be used for compensation planning according to an embodiment of the present invention. FIG. 4 shows a top level manager computer device 410 and a backend computer device 430, each of which is coupled to network 250. Top level manager computer device 410 may be a computer device that is personal to top level manager 110 (such as a personal computer), while backend computer device 430 may be a more centralized computer device (such as a server) that is used indirectly by multiple individuals in the organization.

As shown in FIG. 4, backend computer device 430 may include a central processing unit (CPU) 305 and a memory 440. Memory 440 may be a machine readable medium that is capable of being read by a machine, such as a compact disk, hard drive memory, floppy disk memory, DVD-ROM, CD-ROM or any type of machine-readable (computer-readable) storing medium. Instructions stored on memory 440 may be included within a computer program (which as is well known comprises a plurality of instructions) that is executable by a processor. In the embodiment shown, memory 440 stores compensation planning application 120, which as discussed above may be a software application for compensation planning, and compensation planning data 443, which may be a data file (e.g., in a spreadsheet format) that contains compensation planning data as discussed above.

Top level manager computer device 410 may include a display screen 403, a CPU 405 and a memory 420, which may be a machine readable medium as discussed above with reference to memory 440. As shown in FIG. 4, memory 420 may store email application software 421, spreadsheet application software 422, and compensation planning data 443. In operation, compensation planning application 120 may transmit compensation planning data 443 as an email attachment to top level manager 110 through network 250 (as discussed above). Top level manager 110 may open the email message using email application software 421 and copy compensation planning data 443 from the email message into memory 420. Top level manager 110 may then use spreadsheet application software 422 to open compensation planning data 443 and modify the data by including an allocation of available compensation to business units that are listed in compensation planning data 443. The modified version of compensation planning data 443 may then be transmitted as an email attachment back to compensation planning application 120. In embodiments, each manager is assigned to a computer device that is similar to top level manager computer device 410.

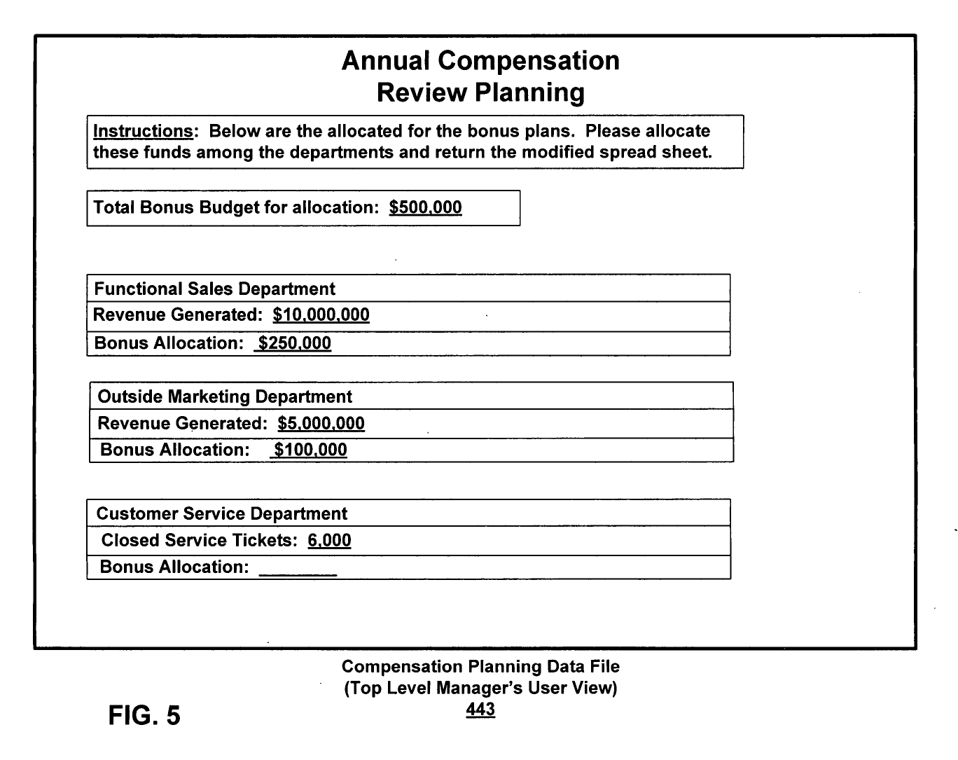

FIG. 5 is a block diagram that show an examples of top level manager's view of a compensation planning data according to an embodiment of the present invention. FIG. 5 shows a user's view of compensation planning data 443, which may be displayed by the user interface for spreadsheet application software 422 on display screen 403 of top level manger's computer device 410. In other words, when top level manager 110 receives the compensation planning data from compensation planning application 120 (which is shown as 104 in FIG. 1), top level manager 110 may cause the compensation planning data to be opened by a spreadsheet application. As shown in FIG. 5, the compensation planning data indicates to top level manager 110 that there is a total budget of $500,000 for all bonuses in the organization. Top level manager 110 may then allocate the bonuses between the three units shown (functional sales department, outside marketing department, and customer service department).

The compensation planning data may indicate that the functional sales department generated revenue of $10,000,000 during the relevant time period, and based on this performance indicator top level manager 110 may allocate $250,000 for bonuses to be distributed among the functional sales department. Similarly, the compensation planning data may indicate that the outside marketing department generated revenue of $5,000,000 during the relevant time period, and based on this performance indicator top level manager 110 may allocate $100,000 for bonuses to be distributed among the outside marketing department. Finally, the compensation planning data may indicate that the customer service department closed 6,000 service tickets during the relevant time period, and based on this performance indicator top level manager 110 may determine an amount to be distributed among the customer service department. Top level manager 110 may then transmit the modified compensation planning data to the compensation planning application 120, shown as 105 in FIG. 1. Of course, the layout and information content shown in FIG. 5 is only an example, and in our embodiments more, less, or different information may be shown.

In some embodiments, indications are provided in the user's view of the data to show the status of the allocations. For example, a red indicator may show that nothing was done so far, a yellow indicator may show that the allocation is in process, and green indicator may show that the allocation is done. In some embodiments, a user may manipulate the format under which the data is presented, in order to create a personalized view of the data pertinent to his decision. In some embodiments, it may be possible for a user to add fields to the planning worksheet. Automatic reminder and escalation procedures may be included to keep involved persons on track.

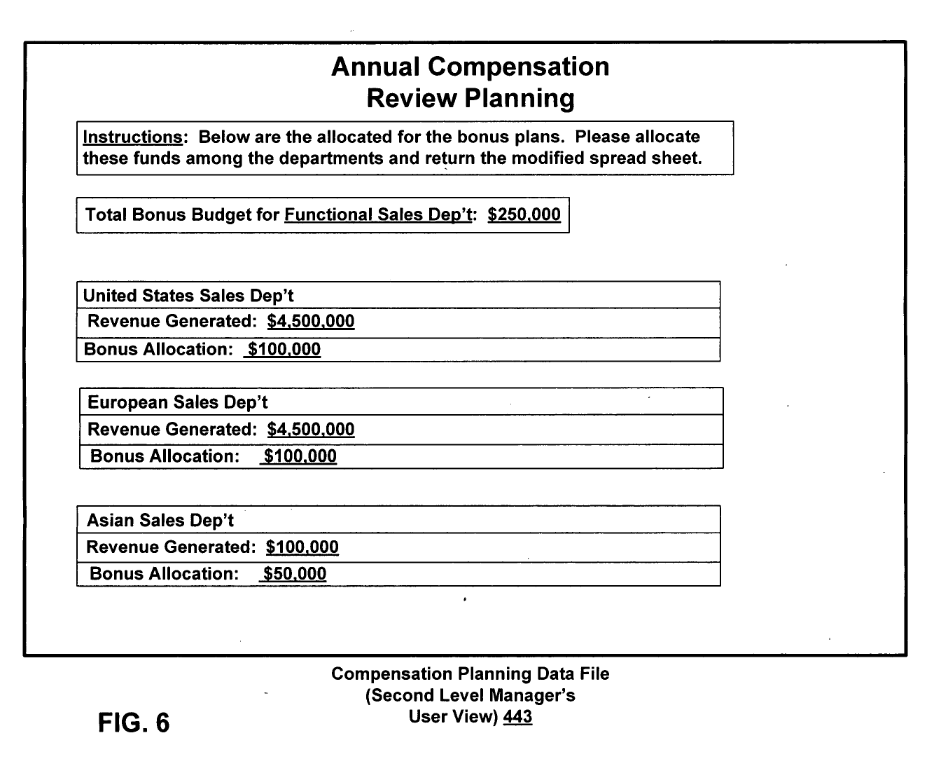

FIG. 6 is a block diagrams that show an example of second level manager's view of a compensation planning data according to an embodiment of the present invention. FIG. 6 shows a user's view of compensation planning data 443 similar to shown in FIG. 5, but in FIG. 6 the compensation planning data is tailored for the second level manager responsible for the functional sales department, which may be second level manager 141. As shown in FIG. 6, the compensation planning data indicates to second level manager 141 that there is a total budget of $250,000 for all bonuses for this unit. Second level manager 141 may then allocate the bonuses between three sub-units for that unit. The compensation planning data may indicate that the United States sales department generated revenue of $4,500,000 during the relevant time period, and based on this performance indicator second level manager 141 may allocate $100,000 for bonuses to be distributed among the United States sales department. Similarly, the compensation planning data may indicate that the European sales department generated revenue of $4,500,000 during the relevant time period, and based on this performance indicator top level manager 110 may allocate $100,000 for bonuses to be distributed among the European sales department. Finally, the compensation planning data may indicate that the Asian sales department generated revenue of $100,000 during the relevant time period, and based on this performance indicator second level manager 141 may allocate $50,000 for bonuses to be distributed among the Asian sales department. Second level manager 141 may then transmit the modified compensation planning data to the compensation planning application 120, shown as 108-109 in FIG. 1.

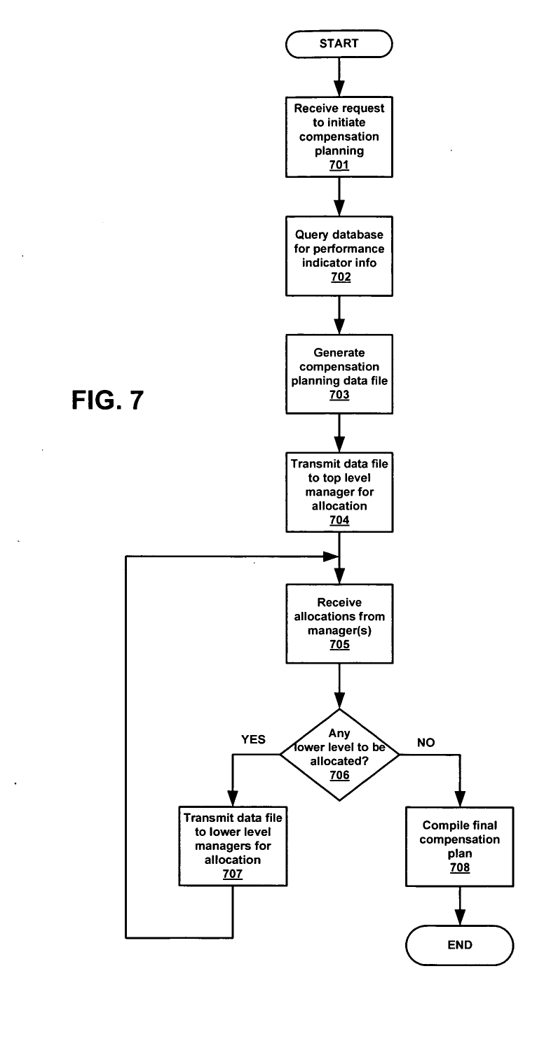

FIG. 7 is a flowchart diagram of a method for employee compensation planning according to an embodiment of the present invention. This method may be performed by compensation planning application 120, as discussed above. A request to initiate a compensation planning process may be received (701), shown as 101 in FIG. 1. A query for performance indicators may be generated and sent to one or more databases (702), shown as 102 in FIG. 1. The performance indicators may measure individual and/or group performance. Some examples of performance indicators include sales revenue generated by a unit, number of contracts generated by a unit, number of tickets solved by a unit, sales revenue generated by an employee, number of contracts generated by an employee, and number of tickets solved by an employee. Other examples of performance indicators include number of contracts made and number of calls made. A performance indicator may include information that indicates the aggregate performance of team or a group of employees.

A compensation planning data set may be generated (703) and may be transmitted to a top level manager for allocation of compensation to the various units in the organization (704). After allocations are received back from the top level manager (705), it may be determined whether the compensation should be further allocated to any lower level subunits (706). If so, the appropriate compensation planning data files are transmitted to the appropriate sub-unit managers for allocation (707). After receiving the allocations from the sub-unit managers (705), a determination is made if there are still some even lower level managers who need to perform an allocation to their respective groups (706). As long as further allocations need to be made, the process repeats until all such allocations have been made. After all such allocations have been made, a final compensation plan is compiled (708).

Embodiments of the present invention provide for distribution of compensation planning worksheets to lower level management, so as to support cascading distribution of compensation planning decisions within a management community. In some embodiments, a method may be implemented on spreadsheet software that is familiar to managers in the organization. In some embodiments, the ability of spreadsheet software to hide and protect fields in a planning sheet may be used to allow dynamic involvement of persons normally not part of the process. By distributing the planning file as an attachment to an email message, managers may receive, process and submit their the data even while they do not currently have an on-line connection established to the organization's private computer network.

The above is a detailed discussion of certain embodiments. It may be understood that the examples discussed are for illustration purposes only and are not intended to limit the configuration to that shown. It is of course intended that the scope of the claims may cover other embodiments than those described above and their equivalents.

What is claimed is:

1. A method comprising:
receiving a request to initiate a compensation planning process for an organization, wherein the request is received at a compensation planning application program executing on a computer system;
generating a query from the compensation planning application to one or more databases to obtain performance indicator information that indicates the performance of units within the organization;
receiving at least one item of performance indicator information at the compensation planning application in response to said query;
creating a data set at the compensation planning application that indicates the available compensation to be allocated, that specifies organizational units, and that includes received performance indicator information;
transmitting said data from the compensation planning application to a first manager to allocate the available compensation among the specified units; and
receiving data at the compensation planning application that reflects the first manager's business unit allocations.

2. The method of claim 1, further comprising compiling a final compensation plan at the compensation planning application based at least in part on the data received from the first manager.

3. The method of claim 1, further comprising:
transmitting data reflecting the first manager's unit allocations from the compensation planning application to managers for the specified units for further allocation among subunits within those units, wherein the data transmitted includes performance indicators for the corresponding subunits; and
receiving data reflecting subunit allocations at the compensation planning application from the unit managers.

4. The method of claim 1, further comprising:
transmitting data reflecting the first manager's unit allocations from the compensation planning application to managers for subunits within those units for further allocation among subunits within those units, wherein data transmitted includes performance indicators for the corresponding subunits; and
receiving data reflecting subunit allocations at the compensation planning application from the unit managers;
transmitting data reflecting the subunit allocations from the compensation planning application to the managers for subunits with that unit for further allocation within those subunits; and
receiving data reflecting the allocations of the subunit managers at the compensation planning application.

5. The method of claim 1, wherein the request to initiate a compensation planning process is received by the compensation planning application as an electronic form.

6. The method of claim 1, wherein said data are in a format recognized by a spreadsheet application program.

7. The method of claim 6, wherein entries in a spreadsheet data file are protected to block access by recipients of the spreadsheet data file to data for groups for which the recipient does not have responsibility.

8. The method of claim 1, wherein the data are transmitted between the compensation planning application and the managers as electronic mail messages.

9. The method of claim 1, wherein the performance indicator information includes information that indicates the aggregate performance of a group of employees.

10. A machine readable medium having embodied thereon a computer program, said computer program being executable by a computer system to perform a method comprising:
receiving a request to initiate a compensation planning process for an organization;
generating a query to one or more databases to obtain performance indicator information that indicates the performance of organizational units;
creating a data set that indicates the available compensation to be allocated, that indicates a grouping of employees being considered for compensation planning into a hierarchical structure, and that includes performance indicator information; and
determining an amount of compensation for each employee, wherein said determining comprises transmitting said data or a derivate of said data to each manager in said hierarchical structure, starting with the highest level managers and proceeding downward through the structure, to allocate the amount of compensation available to each manager among units or employees for which that manager is directly responsible.

11. The machine readable medium of claim 10, wherein the data transmitted to each manager contains one or more performance indicators that indicate the performance for each unit or employee of which that manager is directly responsible.

12. The machine readable medium of claim 10, wherein the data transmitted to each manager is in a format recognized by a spreadsheet application program.

13. The machine readable medium of claim 12, wherein entries in a spreadsheet data file are protected to block access by recipients of the spreadsheet data file to data for groups for which the recipient does not have responsibility.

14. The machine readable medium of claim 12, wherein the data are transmitted to each of the managers as electronic mail messages.

15. A method comprising:
receiving a request to initiate a compensation planning process for an organization, wherein the request is received at a compensation planning application program executing on a computer system;
generating a query from the compensation planning application to a database to obtain performance indicator information relating to the compensation planning process;
creating a data set at the compensation planning application that groups employees in the organization into units and sub-units, wherein the data contains performance indicator information;
transmitting the data from the compensation planning application to a first manager to allocate an amount of compensation among a plurality of units of the organization; and
receiving the data reflecting the first manager's unit allocation at the compensation planning application from the top level manager.

16. The method of claim 15, further comprising:
transmitting data reflecting the first manager's unit allocations from the compensation planning application to the managers for each of the plurality of units for further allocation among subunits within that unit;
receiving at the compensation planning application from the unit managers data reflecting subunit allocations;
transmitting data reflecting the subunit allocations to the managers of the subunits for allocations to employees within the subunits;
receiving data reflecting employee allocations from the subunit managers; and
compiling a final compensation plan at the compensation planning application based on data received from the subunit managers.

17. The method of claim 16, wherein the request to initiate a compensation planning process is received by the compensation planning application as an electronic form.

18. The method of claim 16, wherein said data is in a format recognized by a spreadsheet application program.

19. The method of claim 18, wherein entries in a spreadsheet data file are protected to block access by recipients of the spreadsheet data file to data for groups for which the recipient does not have responsibility.

20. The method of claim 19, wherein the spreadsheet data file is transmitted between the compensation planning application and the managers as electronic mail messages.

21. The method of claim 16, wherein the performance indicator information includes information that indicates the aggregate performance of a group of employees.

22. The method of claim 16, wherein the performance indicator information includes one of sales revenue generated by a unit, number of contracts generated by a unit, number of tickets solved by a unit, sales revenue generated by an employee, number of contracts generated by an employee, or number of tickets solved by an employee.
